(19) United States
(12) Patent Application Publication
(10) Pub. No.: US 2021/0140646 A1
(43) Pub. Date: May 13, 2021

(54) ELECTRIC RANGE SAFETY DEVICE

(71) Applicant: Jae-Hyuck CHANG, Seoul (KR)

(72) Inventor: Jae-Hyuck CHANG, Seoul (KR)

(21) Appl. No.: 17/256,124

(22) PCT Filed: May 2, 2019
(86) PCT No.: PCT/KR2019/005271

§ 371 Date: Dec. 24, 2020

(30) Foreign Application Priority Data
Jun. 26, 2018 (KR) 20-2018-0002930

(51) Int. Cl. F24C 7/08; G01K 11/12

(52) U.S. Cl. CPC F24C 7/083; G01K 11/12

(57) ABSTRACT

One embodiment of the present invention provides an electric range safety device provided on an electric range, wherein the electric range safety device is detachably mounted on a surface provided with a burner of the electric range, and is partially separated by a user's operation so that the burner can be exposed when the electric range is in use.

### TECHNICAL FIELD

The present invention relates to an electric range safety device.

The present application claims the benefit of priority from Korean Utility Model Application No. 20-2018-0002930 filed on Jun. 26, 2018, which is incorporated herein by reference in its entirety.

### BACKGROUND ART

An electric range refers to a cooking appliance that generates heat not by gas but by electricity, and may be classified into an induction, a highlight, a hot plate, and the like according to a heating element. Recently, the electric range tends to be increasingly used, since the electric range is safer than a gas stove due to no gas leakage and convenient for cleaning or the like.

Unlike the gas stove, since the electric range does not generate flame during heating, residual heat after use is not visually regarded as flame, so there is a huge risk of accidents such as burns to users, especially children, or the like.

Further, since the electric range does not have high friction between a top plate surface, on which a burner is provided, and a cooking container such as a pot, the cooking container may easily move from the burner during use, and the cooking container may deviate from the burner.

Therefore, it is necessary to seek a way to increase the user safety upon handling the electric range, and more stably support the cooking container on the burner.

### DISCLOSURE

### Technical Problem

Accordingly, an object of the present invention is to provide an electric range safety device for increasing the user safety upon handling an electric range.

In addition, another object of the present invention is to provide an electric range safety device for more stably supporting a cooking container on a burner of an electric range.

### Technical Solution

To solve the above objects, the present invention provides an electric range safety device, as an electric range safety device provided in an electric range, which is detachably mounted on a surface of the electric range provided thereon with a burner, and partially separated by user operation to allow the burner to be exposed when the electric range is in use.

The electric range safety device may include a cooking container supporter detachably mounted on or around the burner; and a safety cover provided on the cooking container supporter, and detachable from the cooking container supporter by the user operation.

The cooking container supporter may be disposed between a bottom periphery of the cooking container and the burner when the cooking container is seated on the burner.

The cooking container supporter may be provided as a silicon pad.

The cooking container supporter may surround a predetermined periphery of the burner.

The safety cover may be provided with a temperature alarm unit configured to notify a user of changes in temperature around the burner;

The temperature alarm unit may be provided on at least one side of the safety cover, and may be a thermochromic sheet changed into different colors according to the changes in temperature.

The temperature alarm unit may include an LED light source, and may emit light having different colors according to the changes in temperature.

The electric range safety device may include a temperature sensor provided in the safety cover to detect a temperature about the burner; and a control board provided in the safety cover to control the temperature sensor and the temperature notification unit.

### Advantageous Effects

The above various embodiments may provide an electric range safety device, so that the user safety can be increased upon handling an electric range.

In addition, the above various embodiments may provide an electric range safety device, so that a cooking container can be more stably supported on a burner of an electric range.

### DESCRIPTION OF DRAWINGS

The drawings accompanying in the present specification are merely illustrate exemplary embodiments according to the present invention, and serve to further understand the technical idea of the present invention together with the detailed description of the invention to be described later, so the present invention should not be construed to limit the matters described in the drawings.

FIG. 1 is a view for explaining an electric range safety device according to one embodiment of the present invention.

FIG. 2 is an exploded perspective view of the electric range safety device of FIG. 1.

FIG. 3 is a plan view of the electric range safety device of FIG. 1.

FIGS. 4 to 6 are views for explaining states in which the electric range safety device of FIG. 1 is in use.

FIG. 7 is a view for explaining an electric range safety device according to another embodiment of the present invention.

### BEST MODE

### Mode for Invention

The preferred embodiments of the present invention will be described in detail with reference to the accompanying drawings, so the present invention will be more clear and definite. It shall be understood that the embodiments herein are exemplarily described for the further understanding of the present invention, and the present invention may be implemented with various modifications different from the embodiments described herein. In addition, for further understanding of the present invention, the accompanying drawings may not be shown as actual scale, and the dimensions of some components may be exaggerated.

FIG. 1 is a view for explaining an electric range safety device according to one embodiment of the present invention. FIG. 2 is an exploded perspective view of the electric range safety device of FIG. 1. FIG. 3 is a plan view of the electric range safety device of FIG. 1.

Referring to FIGS. 1 to 3, an electric range safety device 10 may be provided in an electric range 1. The electric range 1 may be any one of an induction, a highlight, and a hot plate. Specifically, the electric range 1 may be the induction. The present invention is not limited thereto, and the electric range 1 may be provided as a device including at least one of the induction, the highlight, and the hot plate, and may be provided as another type of device having been commercialized or scheduled to be commercialized for generating heat by electricity.

The electric range safety device 10 may be detachably mounted on a top plate surface provided with a burner 5 of the electric range 1, and may be partially separated by user operation so as to allow the burner 5 to be exposed when the electric range 1 is in use.

Hereinafter, the electric range safety device 10 according to an embodiment of the present invention will be described in more detail.

The electric range safety device 10 may include a cooking container supporter 100 and a safety cover 200.

The cooking container supporter 100, which serves to support the cooking container C (see FIG. 5) mounted on the burner 5 of the electric range 1, may be detachably mounted on the top plate surface of the electric range 1. Specifically, the cooking container supporter 100 may be detachably mounted on the burner 5 or around the burner 5 of the electric range 1.

When the cooking container C is seated on the burner 5, the cooking container supporter 100 may be disposed between a bottom periphery of the cooking container C and the burner 5, so that the cooking container C may be stably fixed and supported.

The cooking container supporter 100 may surround a predetermined periphery of the burner 5 to more stably support the cooking container C, and may increase a friction with the cooking container C by increasing a contact surface with the bottom periphery of the cooking container C.

The cooking container supporter 100 may be provided as a silicon pad having an approximately ring shape. The above silicone pad may have predetermined elasticity and be formed of a member having high heat-resistance. For example, the silicone pad may be formed of a liquid silicone material having a heat-resistance function capable of withstanding up to about 480° C.

Meanwhile, in addition to the above silicone pad, the cooking container supporter 100 may be formed of another material having been commercialized or scheduled to be commercialized for more stably supporting the cooking container C by increasing the friction with the cooking container C.

The safety cover 200 may be provided on the cooking container supporter 100. The safety cover 200 may be detached from the cooking container supporter 100 by the user operation.

Specifically, the safety cover 200 may be disposed on the cooking container supporter 100 when the electric range 1 is not used, thereby preventing the burner 5 of the electric range 1 from being exposed to the outside, and may be separated from the cooking container supporter 100 according to the user operation when the electric range 1 is in use, thereby exposing the burner 5 of the electric range 1 to the outside.

The safety cover 200 may include a cover body 210, a cover handle 230, and a temperature alarm unit 250.

The cover body 210 may define an outer shape of the safety cover 200, and may be formed to approximately have a semicircular shape, a semi-oval shape or the like when viewed from the top. The present invention is not limited thereto, and the cover body 210 may have other shapes for preventing the burner 5 of the electric range 1 from being exposed to the outside when the cooking container supporter 100 covers thereon.

A top surface of the cover body 210 may have a flat shape. Accordingly, in the embodiment, the cooking container C or other kitchen items may be selectively mounted on the cover body 210 as necessary. Further, the cover body 210 may also be used as a stand for the cooking container C or the like, after the separation, when needed by the user. The cover handle 230, which serves to guide the user to attach or detach the safety cover 200 during the user operation, may be provided on one side of the cover body 210. Specifically, the cover handle 230 may be provided in a center of the top surface of the cover body 210.

The temperature alarm unit 250, which serves to notify the user of changes in temperature around the burner 5 of the electric range 1, may be provided on at least one side of the cover body 210 of the safety cover 200.

The temperature alarm unit 250, may be provided along an outer periphery of the cover body 210, and may be provided as a thermochromic sheet changed into different colors according to changes in temperature.

Hereinafter, used states of the electric range safety device 1 according to the embodiment will be described in more detail.

FIGS. 4 to 6 are views for explaining states in which the electric range safety device of FIG. 1 is in use.

Referring to FIG. 4, when the above electric range is in use, the user may remove the safety cover 200 of the electric range safety device 10 from the cooking container supporter 100, so that the burner 5 of the electric range 1 may be exposed to the outside.

In the embodiment, when the electric range 1 is not in use, the burner 5 may be covered by the safety cover 200 to protect the user from risks such as burns, and when the electric range 1 is in use, the burner 5 may be exposed to the outside to implement the convenient user operation for cooking or the like.

Referring to FIG. 5, when the cooking container C is seated on the burner 5, the cooking container supporter 100 may be elastically deformed and come into contact with the bottom periphery of the cooking container C.

In the embodiment, since the cooking container supporter 100 may support the cooking container C on the top plate surface of the electric range 1, the cooking container C may be prevented from slipping or escaping out of the burner 5.

Accordingly, in the embodiment, when the electric range 1 is in use, the cooking container supporter 100 may effectively increase the stability of the cooking container C toward the burner 5.

Further, in the embodiment, the cooking container supporter 100 may stably fix the cooking container C on the burner 5 even when the bottom of the cooking container C is not completely flat.

Referring to FIG. 6, after the use of the electric range 1, residual heat may remain in the burner 5 (see FIG. 5). The temperature around the burner 5 may increase due to the residual heat, and accordingly, the temperature of the cover body 210 of the safety cover 200 may also increase.

When there is a contact, for example, when the user touches the cover body 210 of the safety cover 200, a risk such as an unexpected burn may occur to the user.

In the embodiment, since the user may easily determine the temperature of the burner 5 at the bottom of the safety cover 200 with naked eyes through the temperature alarm unit 250 provided in the safety cover 200, the burn accident due to contact with the safety cover 200 heated by the residual heat can be effectively prevented.

FIG. 7 is a view for explaining an electric range safety device according to another embodiment of the present invention.

An electric range safety device 20 according to an embodiment of the present invention is similar to the electric range safety device 10 of the previous embodiment, so the configuration substantially same as or similar to the previous embodiment will not be described repeatedly, and hereinafter, it will be described focusing on differences with respect to the previous embodiment.

Referring to FIG. 7, the electric range safety device 20 may include a cooking container supporter 100 and a safety cover 300.

Since the cooking container supporter 100 is the same as that of the previous embodiment, hereinafter, duplicate descriptions will be omitted.

The safety cover 300 may include a cover body 310, a cover handle 330, a temperature alarm unit 350, a temperature sensor 370, and a control board 390.

Since the cover body 310 and the cover handle 330 are similar to the cover body 210 and the cover handle 330 of the previous embodiment, hereinafter, duplicate descriptions will be omitted.

The temperature alarm unit 350 may be provided with at least one or a plurality of light sources. Hereinafter, in the embodiment, the temperature alarm unit 350 will be described as being provided with a plurality of light sources.

The light sources of the temperature alarm unit 350 may be provided as LED light sources. The light sources may be spaced apart from each other at a predetermined distance along a peripheral direction of the cover body 310, and may emit light having different colors according to changes in temperature around the burner of the electric range 1.

The temperature sensor 370 may be provided in the cover body 310 of the safety cover 200 to sense the temperature around the burner of the electric range 10. The temperature sensor 370 may be provided as a temperature sensor capable of sensing a temperature.

The control board 390 may be accommodated in the cover body 310 of the safety cover 200 to control the temperature sensor 370 and the temperature alarm unit 350. The control board 390 may include a flexible printed circuit board.

Based on a predetermined temperature, the control board 390 may control the light sources of the temperature alarm unit 350 to represent different light emission colors, when the temperature is equal to or higher than the predetermined temperature and equal to or lower than the predetermined temperature.

For example, the control board 390 may control the light sources of the temperature alarm unit 350 to emit red light when the temperature is higher than or equal to the predetermined temperature, and may control the light sources of the temperature alarm unit 350 to emit blue light when the temperature is lower than or equal to the predetermined temperature.

As the above description, the electric range safety device 20 according to an embodiment of the present invention may enable the user to recognize the emitted color of the light sources of the temperature alarm unit 350 when the electric range 1 is not in use, so as to visually recognize more conveniently the temperature around the burner of the electric range 1.

In addition, in the embodiment, since the temperature alarm unit 350 includes LED light sources, the user can more easily recognize the temperature around the burner of the electric range 1 even at night or the like without lighting.

According to the above various embodiments, the electric range safety device 10 and 20 may be provided to increase the user safety upon handling the electric range 1.

In addition, according to the above various embodiments, the electric range safety device 10 and 20 may be provided to stably support the cooking container C on the burner 5 (see FIG. 1) of the electric range 1.

In the above, the preferred embodiments of the present invention have been shown and described, but the present invention is not limited to the specific embodiments described above. It will be apparent to those having ordinary skills in the art that various modifications are construed to be available within the scope of the claims without departing from the invention, and the modifications shall not be understood individually from the technical idea or prospect of the present invention.

1. An electric range safety device provided in an electric range, wherein the electric range safety device is configured to be detachably mounted on a surface of the electric range provided therein with a burner, and be partially separated by user operation to allow the burner to be exposed when the electric range is in use.

2. The electric range safety device of claim 1, comprising:
a cooking container supporter detachably mounted on the burner or around the burner; and a safety cover provided on the cooking container supporter, and detachable from the cooking container supporter by the user operation.

3. The electric range safety device of claim 2, wherein the cooking container supporter is disposed between a bottom periphery of the cooking container and the burner when the cooking container is seated on the burner.

4. The electric range safety device of claim 2, wherein the cooking container supporter is provided as a silicone pad.

5. The electric range safety device of claim 2, wherein the cooking container supporter surrounds a predetermined periphery of the burner.

6. The electric range safety device of claim 2, wherein the safety cover is provided with a temperature alarm unit configured to notify the user of a temperature change around the burner.

7. The electric range safety device of claim 6, wherein the temperature alarm unit is provided on at least one side of the safety cover, and includes a thermochromic sheet changing a color depending on the temperature change.

8. The electric range safety device of claim 6, wherein the temperature alarm unit includes an LED light source, and emits light having different colors depending on the temperature change.

9. The electric range safety device of claim 8, further comprising:
a temperature sensor provided in the safety cover to sense the temperature about the burner; and a control board provided in the safety cover to control the temperature sensor and the temperature alarm unit.
